(19) United States
(12) Patent Application Publication
(10) Pub. No.: US 2014/0270288 A1
(43) Pub. Date: Sep. 18, 2014

(54) METHOD AND APPARATUS TO DISPLAY INTERFERENCE FOR A WIRELESS HEARING ASSISTANCE DEVICE PROGRAMMER

(71) Applicant: STARKEY LABORATORIES, INC., Eden Prairie, MN (US)

(72) Inventor: Jeff Patrick Kryzer, Maple Grove, MN (US)

(73) Assignee: Starkey Laboratories, Inc., Eden Prairie, MN (US)

(21) Appl. No.: 13/843,852

(22) Filed: Mar. 15, 2013

(51) Int. Cl. H04R 25/00

(52) U.S. Cl. CPC H04R 25/30
USPC 381/314

(57) ABSTRACT

Disclosed herein, among other things, are systems and methods for displaying wireless interference for a wireless hearing assistance device programmer. One aspect of the present subject matter includes a method including measuring levels of wireless interference over wireless communication channels using fitting software configured for a wireless hearing assistance device programmer. The levels of measured wireless interference over time are displayed on a graphical display in communication with the wireless programmer. In various embodiments, displaying the measured wireless interference levels includes using a moving line graph with multiple lines, with each of the multiple lines representing one of the wireless communication channels.

### CROSS REFERENCE TO RELATED APPLICATION

This application is related to co-pending, commonly assigned U.S. patent application Ser. No. 12/552,513, entitled “SYSTEMS AND METHODS FOR MANAGING WIRELESS COMMUNICATION LINKS FOR HEARING ASSISTANCE DEVICES”, filed on Sep. 2, 2009, U.S. patent application Ser. No. ______, entitled “HEARING ASSISTANCE DEVICE WIRELESS TEST MODES AS A DIAGNOSTIC TOOL”, filed on even date herewith (Attorney Docket No. 899.364US1), and U.S. Provisional Patent Application Ser. No. ______, entitled “WIRELESS ENVIRONMENT INTERFERENCE DIAGNOSTIC HEARING ASSISTANCE DEVICE SYSTEM”, filed on even date herewith (Attorney Docket No. 899.366PRV), all of which are hereby incorporated by reference herein in their entirety.

### TECHNICAL FIELD

This document relates generally to hearing assistance systems and more particularly to methods and apparatus for displaying wireless interference for a wireless hearing assistance device programmer.

### BACKGROUND

Modern hearing assistance devices, such as hearing aids, are electronic instruments worn in or around the ear that compensate for hearing losses by specially amplifying sound. Wearers of hearing aids undergo a process called “fitting” to adjust hearing aid settings to their particular hearing and use. In such fitting sessions the wearer may select one setting over another, much like selecting one setting over another setting in an eye test. After the initial fitting process, the wearer may desire further adjustments of hearing aid settings to further tune the device and/or to match different acoustic environments.

Hearing aid settings are adjusted through a programmer that is attached to a personal computer (PC) and that allows a hearing professional, such as an audiologist, to make changes via a software graphical user interface. The programmer communicates from the PC to the hearing aids through either a wired or wireless communication protocol. A wireless programmer is unable to properly communicate with hearing aids when wireless interference is present. Using a spectrum analyzer can help measure and identify wireless interference, but such devices are expensive and most hearing professionals do not have spectrum analyzers available in their offices.

Accordingly, there is a need in the art for improved systems and methods for assessing wireless interference for hearing assistance device programmers.

### SUMMARY

Disclosed herein, among other things, are systems and methods for displaying wireless interference for a wireless hearing assistance device programmer. One aspect of the present subject matter includes a method including measuring levels of wireless interference over wireless communication channels using fitting software configured for a wireless hearing assistance device programmer. The levels of measured wireless interference over time are displayed on a graphical display in communication with the wireless programmer. In various embodiments, displaying the levels of measured wireless interference includes using a moving line graph with multiple lines, with each of the multiple lines representing one of the wireless communication channels.

One aspect of the present subject matter includes a hearing assistance system for a wearer including a wireless hearing assistance device programmer configured to wirelessly communicate with a hearing assistance device using at least one of a plurality of channels. The system also includes a graphical display in communication with the wireless programmer. The wireless programmer is configured to measure levels of wireless interference over the plurality of channels using fitting software configured for the wireless programmer. The graphical display is configured to display the levels of measured interference over time including using a moving line graph with multiple lines, with each of the multiple lines representing one of the plurality of channels, according to various embodiments.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is a block diagram of hearing assistance devices and programming equipment, according to various embodiments of the present subject matter.

FIGS. 2-3 illustrate graphical displays showing wireless interference for a wireless hearing assistance device programmer, according to various embodiments of the present subject matter.

FIG. 4 illustrates a flow diagram of a method for displaying wireless interference for a wireless hearing assistance device programmer, according to various embodiments of the present subject matter.

FIG. 5 illustrates various wireless communication environment(s) with a hearing aid device, according to various embodiments of the present subject matter.

FIG. 6 illustrates a wireless communication network within a multi-office environment with multiple programmers and hearing aids.

FIG. 7 illustrates a block diagram of a hearing aid embodiment.

FIG. 8 illustrates a block diagram of a wireless programmer embodiment.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Hearing aid settings are adjusted through a programmer that is attached to a personal computer (PC) and that allows a hearing professional, such as an audiologist, to make changes via a software graphical user interface. The programmer communicates from the PC to the hearing aids through either a wired or wireless communication protocol. A wireless programmer is unable to properly communicate with hearing aids when wireless interference is present. Using a spectrum analyzer can help measure and identify wireless interference, but such devices are expensive and most hearing professionals do not have spectrum analyzers available in their offices. Therefore, what is needed in the art is an improved system and method for assessing wireless interference for hearing assistance device programmers.

Disclosed herein, among other things, are systems and methods for displaying wireless interference for a wireless hearing assistance device programmer. One aspect of the present subject matter includes a hearing assistance system for a wearer including a wireless hearing assistance device programmer configured to wirelessly communicate with a hearing assistance device using at least one of a plurality of channels. The system also includes a graphical display in communication with the wireless programmer. The wireless programmer is configured to measure a level of wireless interference over the plurality of channels using fitting software configured for the wireless programmer. The graphical display is configured to display the level of measured interference over time including using a moving line graph with multiple lines, with each of the multiple lines representing one of the plurality of channels, according to various embodiments.

The present subject matter assesses link quality for a wireless programmer in communication with one or more hearing assistance devices. An example of this assessment can be found in to co-pending, commonly assigned, U.S. patent application Ser. No. 12/552,513, entitled “SYSTEMS AND METHODS FOR MANAGING WIRELESS COMMUNICATION LINKS FOR HEARING ASSISTANCE DEVICES”, filed on Sep. 2, 2009, which is hereby incorporated by reference in its entirety.

FIG. 1 is a block diagram of hearing assistance devices and programming equipment according to one embodiment of the present subject matter. FIG. 1 shows a host computer 10 in communication with the hearing assistance devices 20. In one application, the hearing assistance devices 20 are hearing aids. Other hearing assistance devices and hearing aids are possible without departing from the scope of the present subject matter. Wireless programmer 30 functions to facilitate communications between the host computer 10 and the hearing assistance devices 20 (e.g., hearing aids) to fit and adjust the devices, and may contain additional functionality and programming in various embodiments. Other numbers of programmers and devices can be used without departing from the scope of the present subject matter.

Host computer 10 is adapted to execute adjusting/fitting software that takes inputs from devices such as a keyboard and mouse for adjusting/fitting one or more hearing assistance device. Options are displayed for adjusting parameters one a computer screen or other graphical display 12. As discussed below, the present subject matter further displays measured wireless interference data over time on a graphical display, such as display 12, in various embodiments. It is understood that the user may be the wearer of one or more hearing aids or can be a clinician, audiologist or other attendant assisting with the use of the adjusting/fitting system. In various embodiments, the system includes memory which stores and displays one or more user selections for the fitting system. It is understood that the configuration shown in FIG. 1 is demonstrative and is not intended in an exhaustive or exclusive sense. Other configurations may exist without departing from the scope of the present subject matter. For example, the display 12 for showing measured wireless interference parameters over time can be located on the programmer 30 or in another external device connected to the programmer directly or indirectly, such as through an internet connection. In addition, it is possible that the memory may be encoded in firmware, software, or combinations thereof.

In various embodiments, a wireless programmer 30 is capable measuring the interference parameters in order to choose a free channel, as discussed below with respect to FIGS. 5-8. In various embodiments, the present subject matter provides a moving graph that collects link quality assessment (LQA) data from the fitting software application for available channels on a periodic basis, such as every few seconds, and plots this on a graphical display screen, such as the display 12. Hearing professionals can observe the display and turn off devices in their office (phones, etc) until the interference goes away. According to various embodiments, the present subject matter displays the interference over time showing a frequent sample (e.g. every 2 seconds) which allows the user to quickly see when interference is present and when it disappears. This gives the user immediate feedback that a change in their environment (e.g. turning off a wireless headset) makes interference go away.

In various embodiments, the present subject matter displays a line graph with multiple lines, representing one line per spectrum channel. FIGS. 2-3 illustrate graphical displays showing wireless interference data or parameters for a wireless hearing assistance device programmer, according to various embodiments of the present subject matter. In the depicted embodiments, the X-axis of the graph represents time, and the Y-axis represents the magnitude of the wireless interference. As time goes by, the graph moves sideways, showing the interference over time in various embodiments. The graph updates frequently so that adding or removing interference nearby can be quickly recognized. The graph is updated every two seconds in an embodiment. Other update rates are possible without departing from the scope of the present subject matter. FIG. 2 illustrates a graph showing very low interference levels, according to various embodiments. The graph shows the interference over time from left to right. FIG. 3 illustrates an example of a graph with a large amount of interference.

In various embodiments, the sample timing can be slowed down to measure interference over a longer period of time. For example, if the wireless programmer is not used after a certain time each day, the graph can take a slower sample after that time. In various embodiments, the graph shows the magnitude of the measured interference throughout the day and if it appears at a certain time each day. Additionally the wireless diagnostics can save the measured values to a file for viewing later, or sending to an external device for analysis, in various embodiments.

According to various embodiments, the graph can be oriented differently than the X- and Y-axes described above. In addition, the interference data can be displayed using a visual mechanism other than a moving line graph, such as a bar graph, scatter graph, numerical display, color display, letter display, or any other symbols which indicate high or low interference, in various embodiments. In one embodiment, the interference data is displayed directly on the wireless programmer on a display panel. In various embodiments, the measured interference data can be sent to another device and displayed on that device, instead of the computer to which the programmer is connected. Examples include a mobile device, a second computer, a web server, a database, or any device connected over a network like the internet. In various embodiments, the interference data can be translated into an audible tone or tones which indicate whether interference is high or low. In one example, an audible alarm is sounded when interference over a selected channel exceeds a programmable threshold. Advantages of the present subject matter include convenience and cost savings, since a hearing device manufacturer will not have to travel to a customer site to diagnose wireless interference.

Various embodiments of the present subject matter gather and process measured interference data, storing the data economically over time. In one embodiment, the measured interference data is transmitted to a remote location for analysis. The measured interference data is used to optimize the programming system, including using it for feedback for future designs, in an embodiment. According to various embodiments, the measured interference data is acted on by the system in real time, or immediately. In other embodiments, the use of the measured interference data is delayed or not in real time. Various system embodiments provide custom channel profiles to be chosen for particular sites to avoid interference. In various embodiments, channel profiles can be refined for each country of use. The gathering of RSSI (Receive Signal Strength Indicator) or EMI (electromagnetic interference) data can be statistically processed or compressed into desired time bins for displaying, in various embodiments. In various embodiments, a channel scan for EMI can be expanded over a broad frequency range to enable identification of receiver out-of-band interferers, if a SAW (surface acoustic wave) filter is switched out or other filters are switched in. In addition, this system can provide for refinement of SAW filter specifications for high EMI scenarios, in various embodiments.

FIG. 4 illustrates a flow diagram of a method 400 for displaying wireless interference for a wireless hearing assistance device programmer, according to various embodiments of the present subject matter. In various embodiments, the method 400 includes measuring wireless interference on multiple communication channels for a wireless hearing assistance device programmer, at 402. Various embodiments use fitting software to measure interference, but other measurements such as standalone applications running on a PC or on the programmer are possible without departing from the scope of the present subject matter. At 404, a parameter related to the measured wireless interference is calculated. At 406, the parameter is displayed for each of the multiple channels. In various embodiments, wireless interference parameter is displayed over time on a graphical display in communication with the wireless programmer. In various embodiments, displaying the wireless interference parameter, such as a level or other data, includes using a moving line graph with multiple lines, with each of the multiple lines representing one of the wireless communication channels. In various embodiments, the calculating step is omitted, and a measured level or other parameter is displayed.

According to various embodiments, displaying the measured wireless interference parameter (or parameters) over time includes sampling the measured wireless interference and updating the display approximately once every 2 seconds. Other sampling frequencies can be used without departing from the scope of the present subject matter. Displaying the measured wireless interference parameter over time includes sampling the measured wireless interference and updating the display at a frequency based on the time of day, in various embodiments. In some embodiments, the method further includes storing the measured wireless interference parameter to a memory. The method also includes sending the measured wireless interference parameter to an external device, in various embodiments. In one embodiment, sending the measured wireless interference parameter includes wirelessly sending the measured interference. Sending the measured wireless interference parameter to an external device includes sending the measured wireless interference to one or more of a mobile device, a personal computer, a web server, a database, or an internet device, in various embodiments. Displaying the measured wireless interference parameter on a graphical display includes using a graphical display attached to a personal computer in communication with the wireless programmer, in an embodiment. Displaying the measured wireless interference parameter on a graphical display includes using a graphical display on the wireless programmer, in an embodiment. The method also includes translating the measured interference parameter into audible tones that indicate whether the measured interference is high or low, in various embodiments.

FIG. 5 illustrates various wireless communication environment(s) with a hearing aid device, according to various embodiments of the present subject matter. The illustrated hearing aid device 510 is an in-the-ear hearing aid that is positioned completely in the ear canal 511. The present subject matter is not so limited, however. In addition to the illustrated in-the-ear style, the features of the present subject matter can be used in other styles of hearing assistance devices, including half-shell, in-the-canal, behind-the-ear, over-the-ear, eyeglass mount, implants, and body worn hearing aids, and further can be used in noise-protection earphones, headphones, and the like.

Referring again to FIG. 5, a wireless communication system in the hearing aid is adapted to communicate with one or more devices. In various embodiments, the hearing aid uses RF wireless communication to communicate with an external programmer 512. The programmer is able to adjust the hearing aid settings such as mode, volume and the like, to download a complete hearing aid program, and to receive data from the hearing aid for data logging, diagnostics, reporting and the like. In various embodiments, the hearing aid wirelessly communicates with an assisted listening system 513 to receive an audio signal, or a device 514 that provides encoded and compressed audio, or a remote control device 515, or another hearing aid 516, or various combinations thereof.

One challenging environment for hearing aid wireless communication involves a multi-office environment where several programmers may be within range of one another and attempt to discover nodes (e.g. hearing aids) simultaneously. In addition many nodes may be within range of each programmer. Furthermore, the multi-office environment may include other wireless services and/or otherwise devices that emit electromagnetic radiation that may adversely affect the desired wireless communication.

FIG. 6 illustrates a wireless communication network within a multi-office environment with multiple programmers and hearing aids. Any of the programmers 612 are capable of discovering and communicating with hearing aids 610. Further, the programmers 612 can be wirelessly networked together, such as illustrated by the wireless network 617. Additionally, some hearing aids (e.g. left/right hearing aids for a patient) can be designed to wireless communicate with each other in addition to the programmers 612 or other communicators.

Some hearing aid embodiments incorporate a scanning feature to reduce the probability of interference. The probability that interference is on multiple channels simultaneously is significantly less, since the conditional probabilities for independent events are multiplied together for the overall probability that both channels will simultaneously experience interference. Interference can increase the duty cycle of the receiver since the detection of energy on a channel above a Receive Signal Strength Indicator (RSSI) threshold causes the receiver to stay awake. Thus, interference can adversely impact the battery life of the hearing aid. Some embodiments use a wake timer that, if the receiver is awake longer than the sleep cycle without receiving a valid packet, causes the receiver to go into a deep sleep mode with a longer sleep cycle until the interference goes away.

A system, such as the one illustrated in FIG. 6, performs a process to discover the nodes in operational proximity. Any number of channels can be assigned as discovery channels. The use of two or more discovery channels considerably increases the odds of successful links in comparison to a single discovery channel as the single channel may already be in use. These channels are reserved for node discovery of hearing aids by programmers. Programmers pick a desirable discovery channel based on a link quality assessment (LQA). Hearing aids scan the discovery channel frequencies prior to establishing a programming link. During discovery, programmers ping for nodes using a broadcast discovery message that is sent out at random intervals. The node is registered with the programmer if an acknowledgement is received by the programmer. Hearing aids register with all programmers in discovery mode within range of the hearing aid, and associate with programmers after being discovered and selected via the programmer's user interface. Once nodes are discovered, the user is notified using the user display of the hearing aids that are within range. The user then can select the nodes with which to establish a link.

Various programmer embodiments use a LQA table which is updated by scanning each available channel and is used by the programmer to determine a desirable channel, on which to establish a wireless communication session, among the available channels. The programmer sends a frequency change message to each hearing instrument. This message is acknowledged by the hearing aid. Normal data transfer to and from the hearing instrument can begin once the link has been established on the desired channel. Some programmer embodiments perform intermittent (e.g. periodic) maintenance throughout the wireless communication session. In some embodiments, the host communications device sends a maintenance message that contains the next available channel in case the link is lost due to interference as well as a transmit power control word. The channel maintenance response from the hearing instrument contains several communications metrics such as the number of successful packets received since the last maintenance response and the number of packets containing errors. This information is used by the programmer to determine the downlink quality and the uplink quality. The programmer is able to determine the downlink quality by comparing the number of no acknowledgments with the number of messages received by the hearing instrument. In addition to statistics collected during maintenance, some programmer embodiments monitor the RSSI of the nodes on each packet received. Some embodiments maintain this signal strength as a moving average in time. The signal strength can be used to adjust the power control of the uplink signal from the nodes. Adjustments can be made during maintenance messages. The links can operate on the fringe of link margin. However, if there is sufficient link margin, various embodiments allow for upstream power reduction (transmission from remote nodes/hearing aids to the host communications device) to save power in the remote nodes. As is discussed below, there are a number of ways to assess the link quality of RF communication links and a number of ways to adjust the RF communication based on the assessed link quality.

FIG. 7 illustrates a block diagram of a hearing aid embodiment. The illustrated hearing aid 710 includes a microphone system 718, a signal processing circuit 719 which may be incorporated as part of a controller, and a speaker 720 referred to as a hearing aid receiver. The microphone system 718 transforms the acoustic energy 721 of sound from an acoustic source 722 into a signal representative of the sound. The signal processing circuit 719 receives the signal from the microphone system 718, and is designed (e.g. programmed) to appropriately adjust the signal to compensate for the hearing impairment of the wearer of the hearing aid. The signal processing circuit 719 outputs a processed signal to the hearing aid receiver 720, which converts the processed electrical signal into a sound perceived by the wearer. The illustrated hearing aid embodiment also includes a wireless communication circuit 723 adapted to transmit and/or receive wireless signals. The wireless communication circuit may include a receiver, a transmitter, or a transceiver. The signal processing circuit 719 (or controller) controls the wireless communication circuit 723 to control the wireless communication with other devices.

FIG. 8 illustrates a block diagram of a host wireless communicator, such as a programmer. The illustrated communicator includes a controller 824 and a wireless communication circuit 825 adapted to transmit and/or receive wireless signals. The wireless communication circuit may include a receiver, a transmitter, or a transceiver. The controller 824 controls the wireless communication circuit 825 to control the wireless communication with other devices. The station can include other elements, such as various input/output devices like a display monitor, keyboard and mouse.

Various embodiments of the present subject matter support wireless communications with a hearing assistance device. In various embodiments the wireless communications can include standard or nonstandard communications. Some examples of standard wireless communications include link protocols including, but not limited to, Bluetooth™, IEEE 802.11 (wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications. Although the present system is demonstrated as a radio system, it is possible that other forms of wireless communications can be used such as ultrasonic, optical, infrared, and others. It is understood that the standards which can be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

It is understood that variations in communications protocols, antenna configurations, and combinations of components may be employed without departing from the scope of the present subject matter. Hearing assistance devices typically include an enclosure or housing, a microphone, hearing assistance device electronics including processing electronics, and a speaker or receiver. It is understood that in various embodiments the microphone is optional. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the wearer.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, audio decoding, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method, comprising:
measuring levels of wireless interference over wireless communication channels using fitting software configured for a wireless hearing assistance device programmer; and
displaying the measured wireless interference levels over time on a graphical display in communication with the wireless programmer, wherein displaying the measured wireless interference levels includes using a moving line graph with multiple lines, with each of the multiple lines representing one of the wireless communication channels.

2. The method of claim 1, wherein displaying the measured wireless interference levels over time includes sampling the measured wireless interference levels and updating the display approximately once every 2 seconds.

3. The method of claim 1, wherein displaying the measured wireless interference levels over time includes sampling the measured wireless interference levels and updating the display at a frequency based on the time of day.

4. The method of claim 1, further comprising storing the measured wireless interference levels to a memory.

5. The method of claim 1, further comprising sending the measured wireless interference levels to an external device.

6. The method of claim 5, wherein sending the measured wireless interference levels includes wirelessly sending the measured interference levels.

7. The method of claim 5, wherein sending the measured wireless interference levels to an external device includes sending the measured wireless interference levels to one or more of a mobile device, a personal computer, a web server, a database, or an internet device.

8. The method of claim 1, wherein displaying the measured wireless interference levels on a graphical display includes using a graphical display attached to a personal computer in communication with the wireless programmer.

9. The method of claim 1, wherein displaying the measured wireless interference levels on a graphical display includes using a graphical display on the wireless programmer.

10. The method of claim 1, further comprising translating the measured interference levels into audible tones that indicate whether the measured interference levels are high or low.

11. A hearing assistance system for a wearer, comprising:
a wireless hearing assistance device programmer configured to wirelessly communicate with a hearing assistance device using at least one of a plurality of channels; and
a graphical display in communication with the wireless programmer,
wherein the wireless programmer is configured to measure wireless interference levels over the plurality of channels using fitting software configured for the wireless programmer, and wherein the graphical display is configured to display the measured interference levels over time including using a moving line graph with multiple lines, with each of the multiple lines representing one of the plurality of channels.

12. The system of claim 11, wherein the graphical display includes using a graphical display attached to a personal computer in communication with the wireless programmer.

13. The system of claim 11, wherein the graphical display includes using a graphical display on the wireless programmer.

14. The system of claim 11, wherein the hearing assistance device includes a hearing aid.

15. The system of claim 14, wherein the hearing aid includes an in-the-ear (ITE) hearing aid.

16. The system of claim 14, wherein the hearing aid includes a behind-the-ear (BTE) hearing aid.

17. The system of claim 14, wherein the hearing aid includes an in-the-canal (ITC) hearing aid.

18. The system of claim 14, wherein the hearing aid includes a receiver-in-canal (RIC) hearing aid.

19. The system of claim 14, wherein the hearing aid includes a completely-in-the-canal (CIC) hearing aid.

20. The system of claim 14, wherein the hearing aid includes a receiver-in-the-ear (RITE) hearing aid.
